(19) United States
(12) Patent Application Publication
(10) Pub. No.: US 2020/0322677 A1
(43) Pub. Date: Oct. 8, 2020

(54) CHARACTERISTIC-BASED ASSESSMENT FOR VIDEO CONTENT

(71) Applicant: SRI International, Menlo Park, CA (US)

(72) Inventors: Gregory Tibor Alexander Kovacs, Palo Alto, CA (US); Arkady Kopansky, Feasterville-Trevose, PA (US); Robert Norman Hurst, JR., Hopewell, NJ (US)

(21) Appl. No.: 16/795,344

(22) Filed: Feb. 19, 2020

Related U.S. Application Data
(60) Provisional application No. 62/829,767, filed on Apr. 5, 2019.

(51) Int. Cl. H04N 21/44; G06N 20/00; H04N 21/43; H04N 21/434; H04N 21/439

(52) U.S. Cl. CPC H04N 21/44008; G06N 20/00; H04N 21/4394; H04N 21/4341; H04N 21/4307

(57) ABSTRACT

This disclosure describes systems that assess video content. A computing system includes an interface configured to an image captured at a destination of the video content. The computing system includes a memory configured to store the received image and at least a portion of a reference image associated with the video content. The computing system includes processing circuitry configured to detect embedded information in the image, the embedded information indicating that the image represents a frame of a test pattern of the video content. The processing circuitry is configured to utilize an implicit knowledge of the test pattern to compare at least a portion of the image to the portion of the reference image stored to the memory, and to automatically determine, based on the comparison, one or more characteristics of the video content segment as delivered at the destination.

This application claims the benefit of U.S. Provisional Application No. 62/829,767 entitled “AUTOMATIC CHARACTERIZATION OF VIDEO PARAMETERS USING A TEST PATTERN OR NATURAL VIDEO” and filed on 5 Apr. 2019, the entire contents of which are incorporated herein by reference in its entirety.

### TECHNICAL FIELD

The disclosure relates to quality assessment for multimedia content.

### BACKGROUND

Multimedia content is often purchased and consumed at different levels of quality. For example, the quality of multimedia content delivered to a subscriber device may vary based on the level of quality set forth in a purchase agreement or service agreement with respect to a source, such as a broadcast service, streaming service, etc. The quality of the delivered multimedia content may also deviate from the agreed-upon quality level owing to various factors, such as network hardware issues, bandwidth congestion, erroneous execution of the service terms, etc. Consumers typically gauge the quality of the multimedia content being delivered through human assessment. For example, consumers may gauge the quality of digital video or analog video content by viewing the rendered video data and assessing the quality based on the appearance of the rendered video content. However, human assessment is prone to error that may result in time wasted and significant expense incurred by a content provider of the multimedia content, which may have to expend resources resolving a faulty human assessment of the quality of the multimedia content delivered.

### SUMMARY

In general, the disclosure is directed to systems configured to assess the quality of multimedia content that is being delivered to a subscriber. In some examples, the systems of this disclosure enable subscribers to capture a portion of the delivered multimedia content (e.g., during playback of the multimedia content), and to provide the captured portion of the content for quality assessment. For example, content quality assessment systems of this disclosure may accept mobile device-shot image(s) and/or video of a television, computer monitor, or any other type of display as an input, whereupon the content quality assessment systems may analyze the input to determine one or more quality metrics of the video content being delivered to the consumer. In some of these examples, the content quality assessment systems of this disclosure may communicate, to the content provider and/or the content consumer, a determination of whether the delivered video meets the minimum quality required to satisfy the terms of the service agreement that is presently in place between the content provider and the content consumer. As such, the content quality assessment systems of this disclosure may be administrated by the content provider, by the content consumer, or by a third party that provides content quality assessments to the content provider and/or the content consumer.

In one example, this disclosure is directed to a computing system configured to assess video content. The computing system configured to determine a quality of video content. The computing system includes an interface, a memory in communication with the interface, and processing circuitry in communication with the memory. The interface is configured to receive an image captured at a destination (e.g., a playback location) of the video content. The memory is configured to store the received image and at least a portion of a reference image associated with the video content. The processing circuitry is configured to detect embedded information in the image, the embedded information indicating that the image represents a frame of a test pattern of the video content. The processing circuitry is further configured to utilize an implicit knowledge of the test pattern to compare at least a portion of the image to the portion of the reference image stored to the memory, and to automatically determine, based on the comparison, one or more characteristics of the video content segment as delivered at the destination.

In another example, this disclosure is directed to a method of assessing video content. The method includes receiving, by a computing device, an image captured at a destination of the video content. The method further includes storing, to a memory of the computing device, the received image and at least portion of a reference image associated with the video content. The method further includes detecting, by the computing device, embedded information in the image, the embedded information indicating that the image represents a frame of a test pattern of the video content. The method further includes utilizing, by the computing device, an implicit knowledge of the test pattern to compare at least a portion of the image to the stored portion of the reference image. The method further includes automatically determining, by the computing device, based on the comparison, one or more characteristics of the video content segment as delivered at the destination.

In another example, this disclosure is directed to an apparatus configured to assess video content. The apparatus includes means for receiving an image captured at a destination of the video content, means for storing the received image and at least portion of a reference image associated with the video content, means for detecting embedded information in the image, the embedded information indicating that the image represents a frame of a test pattern of the video content, means for utilizing an implicit knowledge of the test pattern to compare at least a portion of the image to the stored portion of the reference image, and means for automatically determining, based on the comparison, one or more characteristics of the video content segment as delivered at the destination

In another example, this disclosure is directed to a computing system configured to assess video content. The computing system includes an interface, a memory in communication with the interface, and processing circuitry in communication with the memory. The interface is configured to receive an image captured at a destination (e.g., a playback location) of the video content. The memory is configured to store the received image, a first training data set with a first set of known video characteristics, and one or more additional training data sets synthesized from the first training data set with respective sets of known video characteristics that are variations of the first set of known video characteristics. The processing circuitry is configured to apply a machine learning system trained with the first training data set and the one or more additional training data sets synthesized from the first training data set to classify one or more characteristics of the received image to form a measured classification.

In another example, this disclosure is directed to a non-transitory computer-readable storage medium encoded with instructions. When executed, the instructions processing circuitry of a computing device to receive an image captured at a destination of the video content, to store, to the non-transitory computer-readable storage medium, the received image and at least a portion of a reference image associated with the video content, to detect embedded information in the image, the embedded information indicating that the image represents a frame of a test pattern of the video content, to utilize an implicit knowledge of the test pattern to compare at least a portion of the image to the stored portion of the reference image, and to automatically determine, based on the comparison, one or more characteristics of the video content segment as delivered at the destination.

In another example, this disclosure is directed to a method for synthesizing one or more additional training data sets with respective sets of known video characteristics. The method includes obtaining, by a computing system, a first training data set with a first set of known video characteristics. The method further includes modifying the first training data set to synthesize each of the one or more additional training data sets as a respective variation of the first training data set, wherein each respective set of known video characteristics associated with the one or more additional data sets represents a respective variation of the first set of known video characteristics associated with the first training data set.

In another example, this disclosure is directed to an apparatus. The apparatus includes means for obtaining a first training data set with a first set of known video characteristics, and means for modifying the first training data set to synthesize each of the one or more additional training data sets as a respective variation of the first training data set, wherein each respective set of known video characteristics associated with the one or more additional data sets represents a respective variation of the first set of known video characteristics associated with the first training data set

The quality assessment systems of this disclosure provide technical improvements in the technical field of multimedia content delivery. By determining the quality of multimedia content and communicating the result of the assessment in the various ways set forth in this disclosure, the quality assessment systems of this disclosure improve data precision. For example, if the quality assessment systems of this disclosure communicate a determination that video content being delivered pursuant to a service agreement does not meet the minimum resolution required to fulfil the service terms, the content provider may implement measures to improve the resolution of the video data being delivered to the subscriber device. The content provider may rectify video resolution issues either based directly on the quality assessment received from the quality assessment systems of this disclosure, or in response to a communication from the content consumer who receives the quality assessment from the content quality assessment systems of this disclosure. Additionally, the content quality assessment systems of this disclosure may mitigate or eliminate the time and expense incurred due to the use of human assessment techniques, such as the time and cost incurred to resolve faulty human assessments of the quality of the multimedia content delivered.

The details of one or more examples of the disclosure are set forth in the accompanying drawings, and in the description below. Other features, objects, and advantages of the disclosure will be apparent from the description and drawings, and from the claims.

### BRIEF DESCRIPTION OF DRAWINGS

FIG. 1 is a conceptual diagram illustrating a system in which the multimedia content quality assessment techniques of this disclosure are performed.

FIG. 2 is a block diagram illustrating an example implementation of the quality assessment system shown in FIG. 1.

FIG. 3 is a conceptual diagram illustrating aspects of a frame of a predefined test pattern, in accordance with aspects of this disclosure.

FIG. 4 is a data flow diagram (DFD) illustrating an example of a test pattern analysis process that the quality assessment system of FIGS. 1 and 2 may perform, in accordance with aspects of this disclosure.

FIG. 5 is a data flow diagram (DFD) illustrating an example of a natural video analysis process that the quality assessment system of FIGS. 1 and 2 may perform, in accordance with aspects of this disclosure.

FIG. 6 is a flowchart illustrating an example process that the quality assessment system of FIGS. 1 and 2 may perform in accordance with aspects of this disclosure.

### DETAILED DESCRIPTION

Content quality assessment systems of this disclosure are configured to assess the quality of multimedia content that is being delivered to a content consumer, such as a subscriber of a service agreement. For example, the content quality assessment systems of this disclosure may accept mobile device-shot video of a television or computer monitor as an input, and may analyze the input to determine one or more video quality facets of the video content being delivered to the consumer. In some examples, the content quality assessment systems of this disclosure may utilize an implicit knowledge of pre-designated test patterns of the video to assess the overall quality of the video. In other examples, the content quality assessment systems of this disclosure may use ad hoc portions of the video output to enable random auditing of the video content being delivered to the subscriber. In either scenario, the content quality assessment systems of this disclosure enable both content consumers (e.g., subscribers) and content providers to take appropriate actions, whether manual or automated, to correct the data precision of the video content if the present quality does not meet the predetermined quality set out in a purchase or service agreement.

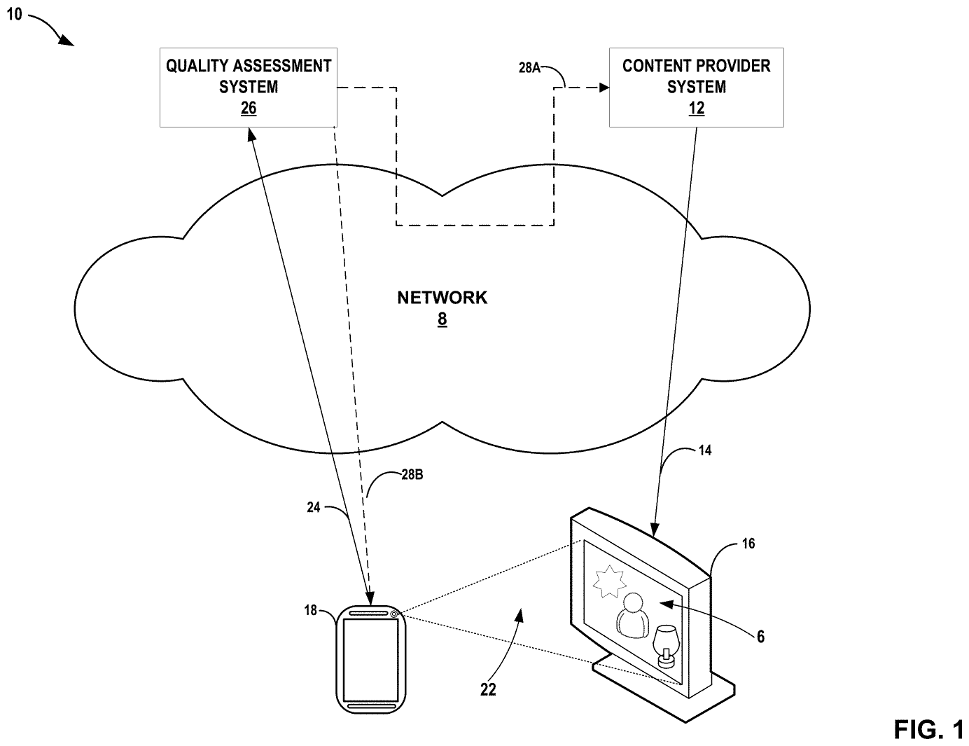

FIG. 1 is a conceptual diagram illustrating a system 10 in which the multimedia content quality assessment techniques of this disclosure are performed. System 10 of FIG. 1 includes network 8, content provider system 12, subscriber device 16, mobile device 18, and quality assessment system 26. Quality assessment system 26 performs techniques of this disclosure, as described below in greater detail, to assess the quality of content rendered by subscriber device 16, based on still photos and/or moving video captured by mobile device 18 and communicated over network 8. It will be appreciated that system 10 represents only one example use case of the multimedia content quality assessment techniques of this disclosure, and that other implementations of the described techniques are also compatible with this disclosure.

In the example of FIG. 1, network 8 represents any of or any combination of wired and/or wireless networks that provide connectivity between computing devices such as a wide-area network (e.g., a public network such as the Internet), a local-area network (LAN), a personal-area network (PAN), an enterprise network, a wireless network, a cellular data network, a cable infrastructure-based data network, a partial optical network, a fiber-to-the-premises (FTTP) network, a telephony infrastructure-based data network, a metropolitan area network (for example, Wi-Fi, WAN, or WiMAX), etc. or combinations of which that may form modern communication infrastructure for a cable television (TV) network, an over-the-air TV network, a satellite TV network, etc.

Content provider system 12 represents a single device or network of devices that a source, such as a service provider, uses to provide multimedia content to one or more subscribers over network 8. The source may provide various types of data, such as compressed video (e.g., as in the case of a streaming service), uncompressed video (e.g., as may be transmitted from broadcast facilities, such as production trucks), still or moving medical image data, surveillance video (e.g., from defense/military sources), etc. Content provider system 12 may provide a number of different services to subscriber premises, including data services, such as video streaming services, audio streaming services, or a combination thereof, such as in the form of Internet protocol TV (IPTV) services, cable TV services, satellite TV services, etc. Content provider system 12 may be configured to provide the multimedia content to downstream subscriber premises at varying video resolutions based on the terms of presently in-place purchase agreements. For instance, the administrator of content provider system 12 may offer lower-resolution video at a cheaper price to reduce bandwidth demands over network 8, while charging increased prices to provide higher-resolution video that consumes greater bandwidth to stream over network 8.

Content provider system 12 streams multimedia content 14 to subscriber device 16 over network 8. Multimedia content 14 represents streaming video delivered as over-the-top (“OTT”) data in the non-limiting examples described herein. Subscriber device 16 represents any equipment or combination of equipment configured to receive multimedia content 14, process the received data, and render the processed data for display. Subscriber device 16 is shown in FIG. 1 and described herein as being a so-called “smart TV,” but in other examples, may be a conventional TV paired with a set-top box, a computing device that includes image processing circuitry coupled to a display device (e.g., a desktop, laptop, or tablet computer), a smartphone, a personal digital assistant (“PDA”), etc.

Subscriber device 16 processes multimedia content 14 to render video output 6. By embedding one or more video test segments in multimedia content 14, content provider system 12 enables quality assessment of multimedia content 14, via evaluation of video output 6. For instance, a subscriber may capture image data reflecting the rendered quality of video output 6 using mobile device 18. Mobile device 18 may be a smartphone or tablet computer. In other examples, the subscriber may capture the image data using other types of devices, such as a digital camera, a wearable device (e.g., smart glasses, virtual reality headset, smartwatch, etc.), or other types of devices that implement or integrate image capture capabilities.

In the use case scenario illustrated in FIG. 1, mobile device 18 captures image data reflecting the display quality of video sample 22. In some non-limiting examples, mobile device 18 executes a client-side application or “app” of this disclosure, which provides the capabilities to pre-process video sample 22 before providing the captured image data to quality assessment devices of this disclosure. In other examples, mobile device 18 provides image capture-related parameters to the quality assessment devices, thereby enabling the quality assessment devices to implement pre-processing using information that describes camera idiosyncrasies, device configurations, and other facets of the image capture of video sample 22 (or portion(s) thereof) by mobile device 18. In instances in which mobile device 18 is configured to pre-process video sample 22, mobile device 18 may invoke a client-side app of this disclosure to stabilize the images for jitter, rotate the images to correct parallax, filter the images for lighting correction, or otherwise adjust video sample 22 to compensate for quality distortions caused by the displacement of mobile device 18 from subscriber device 16 during the recording.

This disclosure describes system configurations by which content provider system 12, one or more subscribers, or neutral third parties may audit and determine whether paid-for higher-resolution video content is being delivered to the subscriber(s), thereby adhering to the tenets of the in-place service agreement. Indeed, because higher-resolution video content generally costs more, the techniques of this disclosure enable the above-named parties to determine whether the subscribers are receiving video that meets the quality for which the subscribers have paid an increased price. Moreover, any corrective measures that content provider system 12 may implement to refine the video resolution to the paid-for level improves data precision of the video content that content provider system 12 signals over network 8. In some examples, to implement these corrective measures, content provider system 12 may modify metadata and/or pixels associated with the video content to modify a visual rendering of the video content at the destination.

Quality assessment system 26 may implement techniques of this disclosure to mitigate ticket resolution costs, in terms of monetary costs as well as in terms of human effort. By automating the content quality assessment process according to the techniques of this disclosure, quality assessment system 26 enables content provider system 12 to correct quality issues with multimedia content 14 in a fast, reliable, and automated manner, saving on the time, effort, and monetary costs that would otherwise be expended to implement quality deviation detection and quality correction by way of traditional ticket resolution techniques.

Moreover, by implementing quality assessment according to the techniques of this disclosure, quality assessment system 26 provides an objective quality assessment of the quality of multimedia content 14 to content provider system 12 and/or to mobile device 18. In this way, any corrective measures implemented by content provider system 12 and/or any quality complaints submitted by the subscriber are based on an objective determination of a deviation in quality. In this way, quality assessment system 26 is configured, according to aspects of this disclosure, to mitigate false positives and/or unnecessary quality adjustments operations that might arise from subjective analysis performed by end-users, which may be faulty or otherwise prone to human error or unpredictability.

In some examples, content provider system 12 may include video test segments or test patterns within the video content streamed to subscribers over network 8. For example, content provider system 12 may include identifying data in one or more frames of a particular segment of the video stream, thereby designating that particular frame or group of frames as a video test segment. By providing these designated, pre-identified video test segments in the video stream, content provider system 12 enables subscribers to test the overall quality of the video stream by using the video test segments as a microcosm for quality assessment. In various examples, content provider system 12 may provide video reference segments to quality assessment devices of this disclosure, against which the quality of the video test segments can be compared for quality assessment of the video stream.

In the use case scenario illustrated in FIG. 1, mobile device 18 transmits video test sample 24 over network 8 to quality assessment system 26. In accordance with aspects of this disclosure, quality assessment system 26 is configured to analyze video test sample 24 to determine whether or not multimedia content 14 is being delivered to subscriber device 16 at least the resolution previously agreed upon. In test pattern-based implementations of this disclosure, quality assessment system 26 is configured to isolate pre-designated test patterns from video test sample 24, and to use an implicit knowledge of the pre-designated test patterns to compare the quality of the isolated test patterns against predetermined benchmark information.

According to ad hoc video sample evaluation techniques of this disclosure, quality assessment system 26 leverages machine learning (ML) or artificial intelligence (AI) training data to determine whether random portions of multimedia content 14 represented by video test sample 24 meet the minimum quality requirements of the agreement presently in place between the subscriber and the content provider.

For example, quality assessment system 26 may apply an ML system trained with a first training data set with a first set of known video characteristics and one or more additional training data sets (e.g., delineated, labeled data sets) synthesized from the first training data set with respective sets of known video characteristics that are variations of the first set of known video characteristics to classify one or more characteristics of the received image to form a measured classification with respect to the received image. In this way, quality assessment system 26 uses the classifier functionalities of the ML system to generate individual instances of measured classifications for each received image based on a base training data set with known characteristics and one or more additional data sets (each with known characteristics) synthesized form the base data set.

According to the implementations of this disclosure that utilize implicit knowledge of test patterns, quality assessment system 26 may isolate the pre-designated test patterns from video test sample 24 by detecting test pattern-identifying information embedded in one or more frames by content provider system 12. For instance, quality assessment system 26 may identify these frames by detecting a barcode embedded in the frames. An example of a barcode format that content provider system 12 may embed (and quality assessment system 26 may detect) to identify the frames that make up a video test segment of multimedia content 14 is a quick response (QR) code. By detecting a QR code in a contiguous sequence of frames, or in the bookending frames of a sequence, or in an interspersed selection of frames of a sequence, quality assessment system 26 may identify that particular sequence of frames as representing a video test segment.

Upon identifying a video test segment, quality assessment system 26 may compare one or more quality-indicating features of the identified video test segment. For example, quality assessment system 26 may benchmark the quality of the identified video test segment against a corresponding reference content segment. In some examples, quality assessment system 26 may obtain reference content segments from content provider system 12, each reference content segment corresponding to a particular test pattern embedded or to later be embedded in multimedia content 14 by content provider system 12. In these examples, quality assessment system 26 may correlate the detected video test segment to a particular reference content segment based on the decoded content of the QR code extracted from video test sample 24. In this way, content provider system 12 and quality assessment system 26 may use different QR codes to delineate and differentiate between different video test segments, and to correlate each video test segment to a corresponding benchmark.

Moreover, quality assessment system 26 may decode the QR code of a video test segment of video test sample 24 to determine one or more qualities to which multimedia content 14 should comply, if properly delivered to subscriber device 16. As some non-limiting examples, quality assessment system 26 may determine characteristics such as the type, the version, or the original format of multimedia content 14 from which video test segment 24 was obtained. Examples of format facets include individual frame resolution, frame rate, color space, audio-video offset information, bit depth information, etc. of multimedia content 14.

Quality assessment system 26 may be operated by the content provider that administrates content provider system 12, by one or more subscribers (e.g., the subscriber who consumes content using subscriber device 16), or a third party with which the content provider and/or subscribers can contract for content quality auditing. FIG. 1 illustrates communications 28, one or more of which quality assessment system 26 may initiate based on certain quality assessment outcomes.

Communications 28 are shown using dashed-lines to illustrate that communications 28 are optional. That is, quality assessment system 26 may not initiate one or even any of quality assessment system 26 in some scenarios. For example, in some scenarios, if quality assessment system 26 determines that a test segment of video test sample 24 meets or exceeds the quality requirements of any in-place agreement with respect to multimedia content 14.

FIG. 1 illustrates communication 28A that quality assessment system 26 may send to content provider system 12, and communication 28B that quality assessment system 26 may send to mobile device 18. For example, quality assessment system 26 may send communication 28A to content provider system 12 to elicit an upward quality correction, if quality assessment system 26 determines that video test sample 24 indicates that the quality of multimedia content 14 is below the agreed-upon quality level. For example, quality assessment system 26 may determine that one or more characteristics of video test sample 24 differ from one or more standard characteristics of multimedia content that meets the agreed-upon quality level. Examples of standard characteristics include one or more of color space information, optical-to-electrical transfer function (OETF) information, gamma function information, frame rate information, bit depth information, color difference image subsampling information, resolution information, color volume information, sub-channel interleaving information, cropping information, Y′CbCr to R′G′B′ matrix information, /Y′UV to R′G′B′ matrix information, a black level value, a white level value, a diffuse white level, or audio-video offset information. Quality assessment system 26 may initiate communication 28A in situations in which the content provider operates quality assessment system 26, in order to correct quality diminishments in multimedia content 14. These implementations are referred to herein as a “friendly” model, in which the content provider operates both content provider system 12 and quality assessment system 26, thereby performing self-audits and self-corrections to the video quality of multimedia content 14.

In other implementations, quality assessment system 26 may initiate communication 28B, for which the destination is mobile device 18. Quality assessment system 26 may initiate communication 28B in situations in which quality assessment system 26 is operated by a third party with which subscribers can contract to audit the quality of multimedia content 14. These implementations are referred to herein as a “neutral” model, in which the quality assessment system 26 is operated by a third party that subscribers (or alternatively, the content provider) can engage to audit the quality of multimedia content 14. In response to receiving either of communications 28, the content provider or the subscriber (as the case may be) may initiate quality correction measures, either directly by the content provider, or via subscriber communication to the content provider.

In this way, the systems of this disclosure enable various entities to determine the quality of multimedia content 14 by evaluating video output 6 as rendered at a subscriber premises. As described above, quality assessment system 26 uses video test sample 24 in the evaluation, where video test sample 24 is an on-premises recording of video output 6 from another device (mobile device 18 in this example). An interface (e.g., network card or wireless transceiver) of quality assessment system 26 may receive video test sample 24, which is itself multimedia content captured and transmitted by mobile device 18 over network 8.

Quality assessment system may store a content segment of the received video test sample 24 to memory, such as to transient memory or to long-term storage. In turn, processing circuitry of quality assessment system 26 may determine that the stored content segment represents a test pattern. As described above, the processing circuitry of quality assessment system 26 may identify the content segment as a test pattern by detecting a “fingerprint” type marker in one or more frames of the content segment. Based on the determination that the content segment represents the test pattern, the processing circuitry of quality assessment system 26 may compare the test pattern to a reference content segment, such as a reference segment obtained directly from the content provider or from another source. Based on the comparison, the processing circuitry of quality assessment system 26 may determine the quality of the content segment.

In some examples, quality assessment system 26 may also evaluate the quality of ad hoc video samples of multimedia content. The ad hoc video samples need not correspond to predefined test patterns. As such, some ad hoc video samples that quality assessment system 26 may evaluate represent so-called “natural” video, in that the attributes of the frames of the evaluated video have not been altered in any way to condition the frames for quality assessment. By evaluating arbitrary samples of natural video, quality assessment system 26 enables continuous and/or random sampling of video output 6 for quality audits, without causing service disruptions or interruptions.

Owing to the arbitrary nature of natural video, quality assessment system 26 may employ a ML-based approach or an AI-based approach to determine the quality of multimedia content 14 in ad hoc sampling-based examples of this disclosure. To leverage ML/AI-based approaches, quality assessment system 26 may form and continually refine training datasets. Quality assessment system 26 may create separate, delineated, labeled training datasets with independently controlled video parameters from known, labeled source video data. Source video data may originate for example, in various color representations (e.g. color spaces), color formats, and resolutions.

As used herein, different color representations may refer to different color spaces, or may refer to different color representations within the same wavelength grouping/range. For example, quality assessment system 26 may synthesize one or more additional training data sets with respective sets of known video characteristics by obtaining a first training data set with a first set of known video characteristics, and modifying the first training data set to synthesize each of the one or more additional training data sets as a respective variation of the first training data set. In this example, each respective set of known video characteristics associated with the one or more additional data sets represents a respective variation of the first set of known video characteristics associated with the first training data set.

Quality assessment system 26 may also train an ML system classifier to assess one or more characteristics of video content using the first training data set and each of the one or more additional training data sets synthesized sing the first training data sets. In one use case scenario, quality assessment system 26 may begin with a clip of video content in a known color space, and synthesize different variations (some or all standard in the industry), to obtain these additional training data sets for training the classifier.

For example, quality assessment system 26 may classify one or more characteristics of the received image to form a measured classification, and compare the measured classification to one or more user-provided specifications. In some examples, quality assessment system may modify one of metadata or pixels associated with the video content based on the measured classification to modify a visual rendering of the video content at the destination. In this way, quality assessment system 26 implements techniques of this disclosure to synthesize training data sets, alleviating issues arising from difficulties in obtaining different training data sets to train a classifier of an ML system.

In some examples of ad hoc video training data formation, quality assessment system 26 may convert the source video data from the original format to a labeled video training dataset, with independent control of each parameter. As part of the conversion process, quality assessment system 26 may accept input video, and process the input video to produce converted output video based on independent permutations of various parameters, such as color space, electro-optical transfer function (EOTF), color space conversion matrix (optionally, if needed), and/or additional parameters. Quality assessment system 26 may assign corresponding labels to different output video sets, based on the particular parameters that were shuffled or otherwise manipulated. While described primarily with respect to streaming content or other multimedia content as an example, the techniques of this disclosure are applicable to other types of image data as well, as such monochrome images, magnetic resonance images (MRIs) or other types of medical images, defense data, etc.

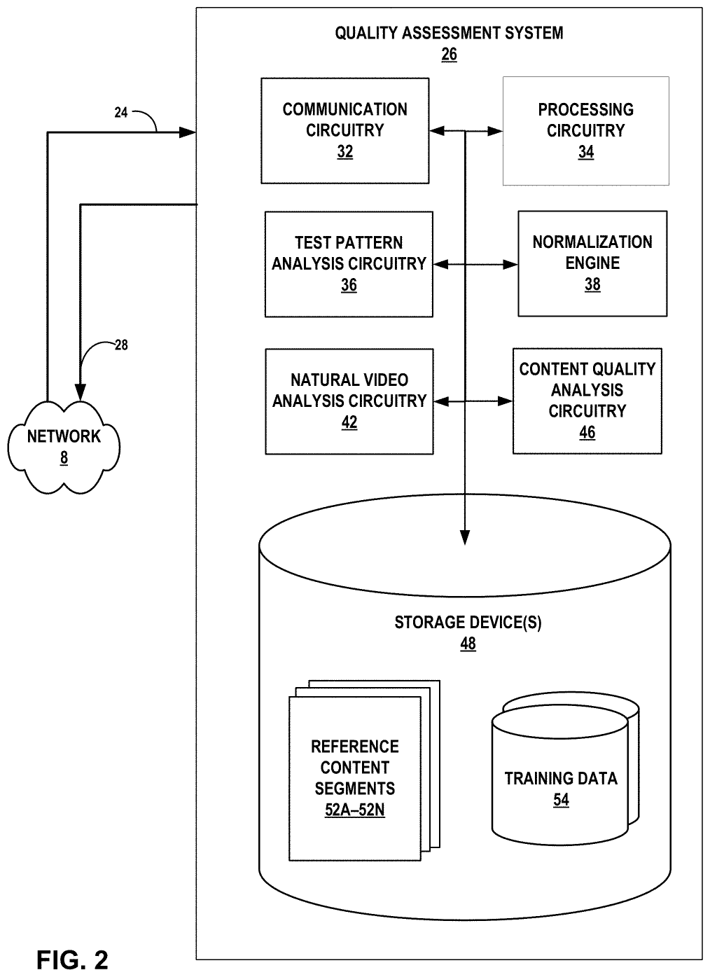

FIG. 2 is a block diagram illustrating an example implementation of quality assessment system 26 shown in FIG. 1. In the example of FIG. 2, quality assessment system 26 includes one or more user communication circuitry 32, processing circuitry 34, test pattern analysis circuitry 36, normalization engine 38, natural video analysis circuitry 42, content quality analysis circuitry 46, and one or more storage devices 48. However, in other examples, quality assessment system 26 may include fewer, additional, or different components and/or circuitry.

Communication circuitry 32 of quality assessment system 26 may communicate with devices external to quality assessment system 26 by transmitting and/or receiving data. Communication circuitry 32 may operate, in some respects, as an input device, or as an output device, or as a combination of input device(s) and output device(s). In some instances, communication circuitry 32 may enable quality assessment system 26 to communicate with other devices over network 8, as shown in the example of FIG. 2. In other examples, communication circuitry 32 may send and/or receive radio signals on a radio network such as a cellular radio network. Examples of communication circuitry 32 include a network interface card (e.g. such as an Ethernet card), an optical transceiver, a radio frequency transceiver, a GPS receiver, or any other type of device that can send and/or receive information. Other examples of communication units 32 may include Bluetooth®, GPS, 3G, 4G, and Wi-Fi® radios found in mobile devices as well as Universal Serial Bus (USB) controllers, and the like. In some examples, quality assessment system 26 may use communication circuitry 32 to offload computationally intensive tasks to other devices with which quality assessment system 26 communicates over network 8.

Processing circuitry 34, in one example, is configured to implement functionality and/or process instructions for execution within quality assessment system 26. For example, processing circuitry 34 may be configured to process instructions stored in storage device(s) 48. Examples of processing circuitry 34 may include any one or more of a microcontroller (MCU), e.g. a computer on a single integrated circuit containing a processor core, memory, and programmable input/output peripherals, a microprocessor (μP), e.g. a central processing unit (CPU) on a single integrated circuit (IC), a controller, a digital signal processor (DSP), an application specific integrated circuit (ASIC), a field-programmable gate array (FPGA), a system on chip (SoC) or equivalent discrete or integrated logic circuitry. A processor may be integrated circuitry, i.e., integrated processing circuitry, and that integrated processing circuitry may be realized as fixed hardware processing circuitry, programmable processing circuitry and/or a combination of both fixed hardware processing circuitry and programmable processing circuitry.

Storage device(s) 48 may be configured to store information within quality assessment system 26 during operation, such as images received from cameras 122 and 124 as described above in relation to FIG. 1. In some examples, storage device(s) 48 include temporary memory, meaning that a primary purpose of the temporary memory portion of storage device(s) 48 is not long-term storage. Storage device(s) 48, in some examples, incorporate volatile memory, meaning that the volatile memory portion of storage device(s) 48 does not maintain stored contents when quality assessment system 26 is turned off or otherwise is not powered on. Examples of volatile memories include random access memories (RAM), dynamic random access memories (DRAM), static random access memories (SRAM), and other forms of volatile memories known in the art. In some examples, storage device(s) 48 is used to store program instructions for execution by processing circuitry 34. In some instances, software or applications running on quality assessment system 26 may use storage device(s) 48 to store information temporarily during program execution.

Storage device(s) 48, in some examples, may include one or more computer-readable storage media. Storage device(s) 48 may be configured to store larger amounts of information than volatile memory. Storage device(s) 48 may further be configured for long-term storage of information. In some examples, storage device(s) 48 includes non-volatile storage elements. Examples of such non-volatile storage elements include magnetic hard discs, optical discs, solid state drives, floppy discs, flash memories, or forms of electrically programmable memories (EPROM) or electrically erasable and programmable (EEPROM) memories.

In the example of FIG. 2, storage device(s) 48 store reference content segments 52A-52N (collectively, “reference content segments 52”) and training data 54. Quality assessment system 26 (or one or more components thereof) may utilize one or both of reference content segments 52 and/or training data 54 in determining whether or not video test sample 24 meets at least a threshold quality level according to the presently in-force terms of the purchase or subscription agreement with respect to multimedia content 14. Component(s) of quality assessment 26 may use reference content segments 52 in test segment-based implementations of this disclosure, and may use training data 54 in natural video assessment-based implementations of this disclosure.

While illustrated separately in FIG. 2, one or more of test pattern analysis circuitry 36, normalization engine 38, natural video analysis circuitry 42, or content quality analysis circuitry may include, be, or be part of processing circuitry 34, or may at least partially overlap with processing circuitry 34. Quality assessment system 26 may invoke test pattern analysis circuitry 36 to determine whether video test sample 24 represents, or at least partially represents, a predefined test segment of multimedia content 14, manifested as video output 6. Test pattern analysis circuitry 36 utilizes an implicit knowledge of pre-designated test patterns to perform various comparison-based characteristic assessments of video test sample 24. Test pattern analysis circuitry 36 may be configured to detect one or more identifier or so-called “fingerprint” pixel groupings within one or more frames of video test sample 24.

If test pattern analysis circuitry 36 detects a fingerprint pixel grouping within certain frames of video test sample 24, test pattern analysis circuitry 36 determines that video test sample 24 represents moving picture data that content provider system 12 embedded in a portion of multimedia content 14 for quality testing purposes. Again, in some examples, test pattern analysis circuitry 36 may detect the fingerprint based on the inclusion of a barcode, such as a QR code, in the analyzed frames of video test sample 24. Test pattern analysis circuitry 36 may recognize differently configured QR or UPC codes to identify particular test segments individually. In other examples, test pattern analysis circuitry 36 may use one or more other image features to identify different test patterns uniquely.

Test pattern analysis circuitry 36 may sub-sample video test sample 24, thereby limiting either or both the spatial and temporal extent of video test sample 24, thereby isolating or substantially isolating the test pattern designated by content provider system 12. Additionally, test pattern analysis circuitry 36 may identify the test pattern type and version. That is, test pattern analysis circuitry 36 may determine (i) that the video test sample 24 includes a test pattern designated by content provider system 12, (ii) which type of test pattern is included in video test sample 24, and (iii) the version number of the identified test pattern. For instance, content provider system 12 may choose from multiple test pattern types to distinguish between different quality standards.

Upon detecting and isolating the embedded test pattern from video test sample 24, test pattern analysis circuitry 36 may invoke normalization engine 38 to implement preprocessing operations to better enable quality assessment of the predefined test segment. Normalization engine 38 may sample eight colors, namely, white, yellow, cyan, green, magenta, red, blue, and black. To sample the eight colors, normalization engine 38 may read one pixel in a color patch, or may combine multiple pixels of a given color patch, such as by averaging the multiple pixels. By implementing the sampling techniques of this disclosure, normalization engine 38 provides the technical improvement of reducing the effects of noise that may be present in the frames of video test sample 24 that can reduce the accuracy of subsequent analyses. By reducing noise in image data under analysis, normalization engine 38 stabilizes the image data to improve the accuracy of the quality assessment process.

Normalization engine 38 may store the three YUV values (one luminance and two chrominance values) for each of the eight color bars to storage device(s) 48 in an array of values. The array is termed analysis data, or ‘ad’ in the notation below. The notation for the array of YUV values for the color bars is ad->bars.yuv[3][8]. Normalization engine 38 normalizes these code values in a later step of the processes described herein. Additionally, normalization engine 38 also saves the raw ‘Y’ code values (i.e. luminance/luma values) to storage device(s) 48. For instance, normalization engine 38 saves the Y value of white as ad->bars.whiteValue, the Y value of black as ad->bars.blackValue, and so on. Similarly, normalization engine 38 saves the U value of blue as ad->bars.uvMax, the U value of yellow as ad->bars.uvMin, the U value of white is saved as ad->bars.uvOffset, and so on. The saved values described above are raw code values, and do not yet represent normalized values.

To normalize the raw luma Y values saved in the ad->bars.yuv[3][8] array, normalization engine 38 may first subtract the ad->bars.blackValue from the respective Y value undergoing normalization, and then divide the resulting difference by the difference between the ad->bars.whiteValue and the ad->bars.blackValue (calculated as (ad->bars.whiteValue)−(ad->bars.blackValue)). Normalization engine 38 may normalize the chrominance/chroma (U and V) values of each color bar by first subtracting ad->bars.uvOffset from the respective chroma value undergoing normalization, and then dividing by the difference between ad->bars.uvMax and ad->bars.uvMin (calculated as (ad->bars.uvMax)−(ad->bars.uvMin)).

As part of normalizing video test sample 24 in cases where video test sample 24 is received YUV format, normalization engine 38 may also determine a YUV-to-RGB matrix from the saved color bar values. For instance, normalization engine 38 may first derive a raw matrix from the normalized YUV values for the R, G, and B colors. The normalized values may contain quantization errors due to the integer nature of the input data (in this case, video test sample 24). In turn, normalization engine 38 may identify the standard matrix (BT.601 format, BT.709 format, or BT.2020 format) that is closest to the raw matrix that was derived from the YUV values for the R, G, and B colors.

The raw matrix includes three rows, namely, one row each for Y values, U values, and V values. More specifically, the top row includes the Y values for the R, G, and B colors, which have indices of 5, 3, and 6, respectively. The notation for the top of the raw matrix is: ad->bars.yuv[0][5,3,6]. The second row from the top includes the U values for the R, G, and B colors, and the notation for the second-from-the-top row is: ad->bars.yuv[1][5,3,6]. The third and bottommost row consists of the V values for the R, G, and B colors, and the notation for the bottommost row is: ad->bars.yuv[2][5,3,6].

While the raw matrix might be usable in converting images of video test sample 24 from YUV format to RGB format, the limited precision of quantized video (as in the case of video test sample 24), the nine values of the raw matrix are often not exact in terms of reflecting the standard values. To improve the accuracy of the normalization process, normalization engine 38 may implement the process based on an assumption that the correct matrix is available as one of a finite set of possible matrices. Normalization engine 38 may compare the nine raw values to a number of standard matrices, and may select the closest match (also termed a “best fit” or “closest fit”) for use in the comparison step. In one example, normalization engine 38 may compare the raw matrix to standard matrices according to the so-called “sum of absolute error” technique. According to the sum of absolute error technique, for each candidate standard matrix used in the comparison, normalization engine 38 takes the absolute difference between the candidate matrix and the raw values, and accumulates the sum of these nine absolute differences. Normalization engine 38 selects the candidate matrix that produced the lowest sum as the “correct” matrix to be used in the YUV-to-RGP conversion.

In some use case scenarios, quality assessment system 26 may receive video test sample 24 in RGB format. In these scenarios, normalization engine 38 may skip the particular subset of normalization steps, namely, the color bar array storage and matrix selection steps. That is, if test pattern analysis circuitry 36 determines (e.g., based on color space information indicated in the fingerprint data) that video test sample 24 was received in RGB format rather than in YUV format, then normalization engine 38 may perform the normalization process directly in the RGB domain, without the need for any preprocessing-stage format conversion to express video test sample 24 in RGB format.

Using the RGB values, whether received directly via video test sample 24 or obtained via YUV-to-RGB conversion, normalization engine 38 may determine a nonlinear transfer function that is sometimes termed as a “gamma” function. RGB values in video are conveyed in a non-linear form, and are not proportional to intensity. RGB values are often encoded or “companded” to better match a quantized channel and thereby better suit human vision characteristics. The gamma function provides an optical-to-electrical conversion as a result. As such, the gamma function is referred to herein as an optical-to-electrical transfer function (or “OETF”).

Several different standards are presently in use for nonlinear functions. Prior to color patches being in interpretable form, the color patches must be processed via an inverse function. That is, to determine an RGB container gamut during downstream processing steps, the nonlinearity that is imposed in current video standards must first be decoded, via application of the inverse function.

This disclosure describes two techniques by which normalization engine 38 may determine an inverse to the OETF. In one example, normalization engine 38 may use a “luminance stairstep” feature to select one of the commonly-used standard OETFs. In some use case scenarios of applying the luminance stairstep technique, normalization engine 38 may not recognize the OETF, such as due to upstream tone-scale mapping. If normalization engine 38 does not recognize the OETF, then normalization engine 38 may derive an inverse function using a wide-range luminance ramp feature of the designated test pattern gleaned from video test sample 24.

In another OETF-derivation technique of this disclosure, normalization engine 38 may not “name” or otherwise label the individual OETFs. According to this OETF derivation technique, normalization engine 38 may convert the code values to linear light during execution of a later computational stage to determine the container color space.

According to one implementation of the stairstep technique, normalization engine 38 may obtain the OETF using a sixteen-step procedure. Normalization engine 38 may store normalized step value sequences for each of the common OETFs to storage device(s) 48. Three examples for BT.709 format, the perceptualized quantizer (PQ) transfer function, and the hybrid log gamma (HLG) standard are presented below:
ss709[ ]={0.00000, 0.00000, 0.00000, 0.00114, 0.00228, 0.00457, 0.00913, 0.01712, 0.03539, 0.07078, 0.13128, 0.21689, 0.33219, 0.48973, 0.70548, 1.00000};
ssPQ[ ]={0.09817, 0.12671, 0.15982, 0.19977, 0.24658, 0.29795, 0.35502, 0.41667, 0.48402, 0.55365, 0.62671, 0.70091, 0.77626, 0.85160, 0.92694, 1.00000}; and
ssHLG[ ]={0.03082, 0.04224, 0.06050, 0.08562, 0.12100, 0.17123, 0.24201, 0.34247, 0.48402, 0.64269, 0.78196, 0.91324, 1.04110, 1.09018, 1.09018, 1.09018}.

Normalization engine 38 may also store other lists instead of or in addition to these lists, to storage device(s) 48 for other OETFs. Normalization engine 38 may sample the luminance stairstep upon input receipt to obtain the sixteen values that correspond to the stored reference lists. Normalization engine 38 may normalize the Y values of the samples in the same way the color bar samples were normalized, i.e. by removing the offset, and then scaling the range. For each stored sequence, normalization engine 38 may accumulate the absolute difference values between the respective pairs of stored sequence and the captured sequence, to form a sum of absolute error (SAE) aggregate. Normalization engine 38 may implement a further improvement of this disclosure by comparing only the first (darker) ‘N’ number of values in the step sequence. Limiting the comparison to only the darker values accounts for the general tendency that the darker values will rarely be modified in upstream processing stages, while the brighter values are commonly modified in the upstream processing stages.

If normalization engine 38 determines that the lowest SAE is below a particular threshold, then normalization engine 38 may identify the lowest SAE as a successful match. In this scenario, normalization engine 38 may set the ad->OETF.name to the name of the respective OETF corresponding to the lowest SAE value that is below the predetermined threshold value. In one use case example, normalization engine 38 may set ad->OETF.name to “HLG” if the “HLG” OETF corresponds to the lowest SAE value that is also below the threshold. Otherwise, if the lowest SAE value is not below the predetermined threshold value, the OETF is considered “unknown” and normalization engine 38 sets the ad->OETF.name to “Unknown.”

In scenarios in which normalization engine 38 sets ad->OETF.name to “Unknown,” normalization engine 38 may invoke the wide range luminance ramp technique of this disclosure. According to the wide range luminance ramp technique, normalization engine 38 forms a relatively continuous sequence of luminance values, instead of steps. Normalization engine 38 may use the sequence of values to develop an inverse lookup table (LUT), and may use the LUT in place of an inverse OETF. Because the ramp is invariant across lines, one video line of the ramp is sufficient, although normalization engine 38 may average multiple lines of the ramp to improve robustness against noise. Normalization engine 38 makes table available in the data structure ad->inverseLut10b.table[1024], and has access to the original linear light function for the ramp.

In some examples of the wide-range luminance ramp technique, normalization engine 38 may use a power function of the relative position, moving from left to right. In one example, normalization engine 38 may apply the equation y=x\hat{ }4. By using a power function such as the equation shown above, normalization engine 38 skews the use of the horizontal range towards darker pixel values.

For each pixel of the ramp, normalization engine 38 uses the ten-bit Y value as an index of the table, and sets the value (table entry) identified by the index being used as the original function. In this example, the original function is y=x\hat{ }4, and for each pixel position index (e.g., index of ‘ii’), ad->inverseLut10b.table[y_value[ii] ]=(ii/width)\hat{ }4. Normalization engine 38 may use this inverse LUT to convert the code values to linear light values.

After obtaining the OETF for the test pattern gleaned from video test sample 24, normalization engine 38 may determine the RGB container gamut for the test pattern obtained from video test sample 24. RGB values are conveyed in the context of three specific color primaries. In the CIE 1931 color space (expressed using (x, y) Cartesian coordinate pairs), these three color primaries form a triangle. Represented in this two-dimensional way, the area within the triangle represents the full set of colors that can be represented by RGB values. The range of colors included in the area within the triangle constructed in this way is referred to as the “color gamut.” The color gamut representation depends on the (x,y) coordinate pair indicating the position of each of the primaries. Several (e.g., in the order of dozens of) “standard” color space gamuts may exist. Some examples, include the ICtCp color space, the XYZ color space, the xyY color space, the CIELAB L*a*b* color space, the CIELUV L*u*v* color space, etc.

The test pattern included in video test sample 24 may contain a number of reference colors (or “color chips”) for which the original (x,y) coordinates are known or are otherwise available to normalization engine 38. Normalization engine 38 may set ad->gamut.name=“Unknown,” thereby leaving the gamut label open for derivation. To analyze the gamut, normalization engine 38 may implement the following procedure, in which the steps are listed in a nested bullet fashion.

1. Convert from YUV to R′G′B′. The apostrophes (or ‘primes’) next to the R, G, and B labels indicate non-linear values.
2. If ad->OETF.name is NOT set to “Unknown” then:

a. Convert to linear light using the inverse OETF for R′G′B′ to RGB; otherwise:

b. Convert to linear light using the inverse LUT entry for R′G′B′ to RGB

3. For each candidate container gamut (i.e., a respective set of color primaries and a respective white point):

a. Convert RGB to xyY, and discard Y
i. For each reference color chip:
ii. Compute the distance from the respective color chip's actual observed (x,y) position to its expected (x,y) position; and
iii. Accumulate sum of squared differences (SSEs).

b. Keep track of the best (e.g., lowest) SSE of the accumulated SSE values

4. If the lowest SSE is lower than a fixed, minimum threshold, declare a match.
5. If a match is declared, save the name of the gamut to a data structure implemented in storage device(s) 48. For example, normalization engine 38 may save the gamut name by executing the following instruction: ad->gamut.name=“PQ” if the declared match complies with the perceptual quantizer (PQ) transfer function.

Upon determining the RGB container gamut corresponding to the test pattern detected in video test sample 24, normalization engine 38 may determine the precision (e.g. as represented by a bit depth metric) of the pixel data of video test sample 24. Often, high quality video data is transmitted using ten-bit values. Some equipment may process and pass only the eight most-significant bits (MSBs) of the ten-bit data and, drop the two least significant bits (LSBs). For example, some equipment may truncate the ten-bit values of the high quality video data in this way for resource-saving reasons, or due to configuration errors. As such, although various communication interfaces transport data at ten-bit, the image data being processed is limited to eight-bit precision.

Normalization engine 38 implements a “shallow ramp” feature of this disclosure to use an even or a substantially even distribution of code values over a limited (or “shallow”) range. For each code value in the shallow ramp, normalization engine 38 may isolate the two LSBs. The two LSBs together represent values selected from the following set: {0, 1, 2, 3}. A true ten-bit representation would include roughly equal proportions of these four values. If an example of a representative histogram is constructed for the values represented by the two LSBs of a true ten-bit signal, the approximately equal counts for each value below describe individual bins of the histogram:

LSBs=0: 14016

LSBs=1: 14243

LSBs=2: 14119

LSBs=3: 14266

The counts of values represented by the two LSBs of an example ten-bit signal where the two LSBs have been set to zero are as follows:

LSBs=0: 56644

LSBs=1: 0

LSBs=2: 0

LSBs=3: 0

While the result is not always as clear-cut as three out of four possible counts being zero, a single count still often dominates over the other three. Normalization engine 38 may normalize the counts by identifying the maximum count (“max”) and the minimum count (“min”). Using the max and min values obtained in this fashion, normalization engine 38 may compute a “skewness” statistic according to the following equation:

skewness=(max−min)/max

For the first example described above (a ten-bit scenario), the result of the skewness calculation is 0.018 (calculated as (14266−14016)/14266 which yields 250/14266, which yields a value of 0.018). For the second example described above (an eight-bit scenario), the result of the skewness calculation is 1.0 (calculated as (56644−0)/56644, which yields 56644/56644, which yields a value of 1.0).

Normalization engine 38 may use a threshold skewness value to distinguish between eight-bit and ten-bit data of video output 6, as it is reflected in video test sample 24. For example, if the skewness is less than 0.2, normalization engine 38 determines that video test sample 24 indicates ten-bit precision for video output 6. On the other hand, if the calculated skewness value is equal to or greater to 0.2, normalization engine 38 determines that video test sample 24 indicates eight-bit precision for video output 6. Normalization engine 38 may use the two-LSB-based algorithm to distinguish between a twelve-bit container and ten-bit content obtained therefrom. Normalization engine 38 may implement a similarly-structured four-LSB-based algorithm to distinguish between a twelve-bit container and eight-bit content obtained therefrom.

Upon normalization engine 38 normalizing the test pattern obtained from video test sample 24, content quality analysis circuitry 46 performs comparison operations of this disclosure to determine whether video output 6 satisfies video quality requirements set forth in a subscription or purchase agreement with the content provider that operates content provider system 12. Content provider system 12 generates the test pattern of multimedia content 14 using a frame counter feature that embeds a frame count number of each frame in a looping sequence of multimedia content 14, such that the looping sequence represents the video test pattern. In some examples, each frame count number is represented as a sequence of binary format bits, with each bit corresponding to a block.

Content provider system 12 may set a respective bit to a value of ‘1’ if the corresponding block is brighter than a predetermined threshold (e.g., if the ‘Y’ value meets or exceeds a threshold value in the case of a YUV-format image), or may set a respective bit to a value of ‘0’ if the corresponding block is darker than the predetermined threshold (e.g., if the ‘Y’ value falls short of the threshold value in the case of a YUV-format image). The length of the loop (namely, half of the total duration of the loop) determines the largest offset that content quality analysis circuitry 46 can determine within a reasonable margin of ambiguity.

While described above with respect to video frames as an implementation example, content quality analysis circuitry 46 may analyze designated audio clips of the audio aspects of multimedia content 14 (as captured and transmitted by mobile device 18) as well. For instance, content provider system 12 may embed pseudorandom values (or “pink noise” as the pseudorandom values are collectively referred to herein) in the audio portion of multimedia content 14, for the same loop duration as the video test pattern. The audio clip may represent a continuously active sequence of audio frames (e.g., as opposed to a short “beep” once per loop that is otherwise silent). As such, the audio clip associated with a single frame of video is sufficient to determine an audio offset, provided that each segment of audio associated with a frame is unique within the audio sequence. In some examples, content provider system 12 may implement a further improvement in terms of robustness to channel distortions using various encoding techniques, such as frequency modulation (FM) encoding (also referred to as “delay encoding”), which is robust against changes in amplitude, phase, polarity, dynamic range compression, etc. In some examples, content provider system 12 may implement another improvement by including a unique audio signature that would enable components of quality assessment system 26 to identify the audio sequence as a test segment.

According to the audio quality assessment aspects of this disclosure, content quality analysis circuitry 46 may have access to a copy of the entire audio loop, such as in the form of a particular entry of reference content segments 52. In one particular use case example, reference content segments 52 may include a reference audio loop that is two seconds long. At a sampling rate of 48,000 samples per second, the reference audio loop includes 96,000 samples, in this particular example. If the corresponding reference video segment is two seconds long, and if the corresponding reference video segment has a frame rate of 60 frames per second, then the reference video segment corresponds to 800 audio samples per video frame.

In cases in which content quality analysis 46 determines that an input video frame is captured in combination with corresponding audio data, content quality analysis 46 may determine the frame number by reading the binary code according to the frame counter feature described above. In the two-second video and audio scenario described above, content quality analysis circuitry 46 may determine the position of the 800-sample section within the reference two-second loop by comparing the section to discrete sections of the stored 96,000-sample clip by correlation or via a similar process. Content quality analysis circuitry 46 may compare the measured position to the expected position of the section, based on the frame number. For instance, if the frame number is 42, the expected sample position would be 33,600 (i.e., (42*800)). If the measured sample position is 34,600, then the audio occurs 1000 samples later (calculated as is 34600-33600), or 1000/48000=0.021 milliseconds.

Content quality analysis circuitry 46 may identify one or more of reference content segments 52 that correspond to the test pattern obtained from video test sample 24. Content quality analysis circuitry 46 may compare the quality of the normalized version of the test pattern obtained from video test sample 24 to the identified reference content segment(s) 52 to determine whether the quality of the test pattern matches or nearly matches (e.g., deviates within a predetermined threshold delta) from the quality of the identified reference content segment(s) 52.

If content quality analysis circuitry 46 detects a match or a near-match (e.g., similarity within a predefined threshold delta) between the normalized version of the test sample obtained from video test sample 24 and the identified reference content segment(s) 52, content quality analysis circuitry 46 may determine that multimedia content 14 satisfies the quality requirements set forth in the presently in-place service agreement between the content provider and the subscriber. Conversely, if content quality analysis circuitry 46 determines that the quality of the normalized version of the test pattern obtained from video test sample 24 deviates from the quality of the identified reference content segment(s) 52 by the predefined threshold delta or greater, then content quality analysis circuitry 46 may determine that multimedia content 14 does not satisfy the quality requirements of the service agreement that is presently in place between the content provider and the subscriber.

If content quality analysis circuitry 46 determines, in this way, that multimedia content 14 does not satisfy the quality requirements of the service agreement, content quality analysis circuitry 46 may cause communication circuitry 32 to signal communication 28 (which may be an example of any of communications 28 of FIG. 1) over network 8. In some examples, content quality analysis circuitry 46 sends communication 28 to content provider system 12. In these examples, content provider system 12 may implement any necessary corrective measures to rectify the quality of multimedia content 14, in response to receiving communication 28 from quality assessment system 26. In other examples, content quality analysis circuitry 46 sends communication 28 to mobile device 18. In these examples, the subscriber may, in response to receiving communication 28 from quality assessment system 26, initiate a procedure to cause the content provider to rectify the quality of multimedia content 14.

In various use case scenarios, quality assessment system 26 may assess the quality of multimedia content 14 using random samples video output 6, if video test sample 24 reflects a random selection from video output 6. For instance, in some cases, mobile device 18 may capture portions of video output 6 that do not include any portions of a predefined test pattern. In these examples, quality assessment system 26 may invoke natural video analysis circuitry 42 to assess the quality of multimedia content 14 using ad hoc selections of video output 6, as captured by mobile device 18 at the destination (e.g., playback location), which may be at the subscriber premises.

If test pattern analysis circuitry 36 does not detect any predefined fingerprint information in video test sample 24, test pattern analysis circuitry 36 may determine that video test sample 24 represents an ad hoc capture of video output 6, also referred to herein as “natural video” captured at the destination of video output 6. If test pattern analysis circuitry 36 determines that video test sample 24 represents natural video, normalization engine 38 may perform natural video normalization techniques of this disclosure. To normalize natural video of video test sample 24, normalization engine implements the shallow ramp techniques described above to perform bit depth-based normalization. That is, normalization engine 38 may collect the same two bits (i.e. the two LSBs) as described above with respect to test pattern normalization, because the two LSBs of natural video samples are also expected to include equal or approximately equal proportions of the four values (namely, 0, 1, 2, and 3) as described above with respect to the predefined test patterns.

Natural video analysis circuitry 42 implements techniques of this disclosure to enable quality assessment system 26 to perform in-service assessment of ad hoc samples of video output data 6 as captured by mobile device 18. The ability to analyze arbitrary samples of natural video enables subscribers or content providers to assess the as-delivered quality of multimedia content 14 while maintaining the continuity of video output 6, without service interruptions. Because arbitrarily-selected natural video captured by mobile device 18 need not include any portions of a predefined test pattern embedded in multimedia content 14 by content provider system 12, the test-pattern-based approaches described above with respect to test pattern analysis circuitry 36 may not be applicable natural video analysis circuitry 42 in the same form.

Instead, natural video analysis circuitry 42 may implement machine learning (ML) and/or artificial intelligence (AI)-based techniques to assess the quality of video output 6 in instance in which video test sample 24 represents arbitrarily captured natural video. To implement the ML/AI-based quality assessment techniques of this disclosure, natural video analysis circuitry 42 may use training data 54 available from storage device(s) 48. Training data 54 include, but are not necessarily limited to, datasets that are applicable to video test sample 24 in cases in which video test sample 24 represents an ad hoc natural video capture with respect to video output 6 as rendered at the destination (e.g., the playback location).

Natural video analysis circuitry 42 may use any of a number of ML models to assess the quality of ad hoc video samples, examples of which include, but are not limited to, neural networks, artificial neural networks, deep learning, decision tree learning, support vector machine learning, Bayesian networks, graph convolutional networks, genetic algorithms, etc. Natural video analysis circuitry 42 may also train the classifier information using different aspects of the input signal(s) using any of supervised learning, reinforcement learning, adversarial learning, unsupervised learning, feature learning, dictionary learning (e.g., sparse dictionary learning), anomaly detection, rule association, or other learning algorithms.

Because obtaining a large volume of natural video in various permutations of known, correctly specified color spaces, EOTFs, YUV-to-RGB conversion matrices, and other video parameters (where each parameter is independently controlled) may not be feasible in many scenarios, quality assessment system 26 may implement techniques of this disclosure to include labeled datasets in training data 54. For instance, processing circuitry 34 may generate training data 54 using independently controlled video parameters from a known, properly labeled source video or reference video. In one example, processing circuitry 34 may generate training data 54 using source video that originated in the 709 color space, with a 1886 gamma value, and with a 709 YUV-to-RGB color conversion matrix.

As part of forming training data 54, processing circuitry may convert the source video material to a labeled video, with each parameter under independent control. With respect to the color space and RGB container gamut, processing circuitry 34 may, in addition to the source 709 content, also produce content converted to P3, 2020, or other color spaces, as part of generating training data 54. With respect to the EOTF, processing circuitry 34 may, in addition to the 1886 gamma, also produce content in PQ, HLG, S-Log3, or other EOTFs, as part of generating training data 54. With respect to the YUV-to-RGB color conversion matrix, processing circuitry 34 may, in addition to the 709 matrix, produce content with 601 and/or 2020 matrices, as part of generating training data 54.

Natural video analysis circuitry 42 may compare the normalized version of the natural video of video test sample 24 to training data 54, or to certain discrete portions thereof. If natural video analysis circuitry 42 detects a match or a near-match (e.g., similarity within a predefined threshold delta) between video test sample 24 and training data 54, natural video analysis 42 may determine that multimedia content 14 satisfies the quality requirements set forth in the presently in-place service agreement between the content provider and the subscriber. Conversely, if natural video analysis circuitry 42 determines that the quality of the normalized version of the natural video of video test sample 24 deviates from the quality of training data 54 by the predefined threshold delta or greater, then natural video analysis circuitry 42 may determine that multimedia content 14 does not satisfy the quality requirements of the service agreement that is presently in place between the content provider (or source) and the subscriber.

If natural video analysis circuitry 42 determines, in this way, that multimedia content 14 does not satisfy the quality requirements, natural video analysis circuitry 42 may cause communication circuitry 32 to signal communication 28 (which may be an example of any of communications 28 of FIG. 1) over network 8. In some examples, natural video analysis circuitry 42 sends communication 28 to content provider system 12. In these examples, content provider system 12 may implement any necessary corrective measures to rectify the quality of multimedia content 14, in response to receiving communication 28 from quality assessment system 26. In other examples, natural video analysis circuitry 42 sends communication 28 to mobile device 18. In these examples, the subscriber may, in response to receiving communication 28 from quality assessment system 26, initiate a procedure to cause the content provider to rectify the quality of multimedia content 14.

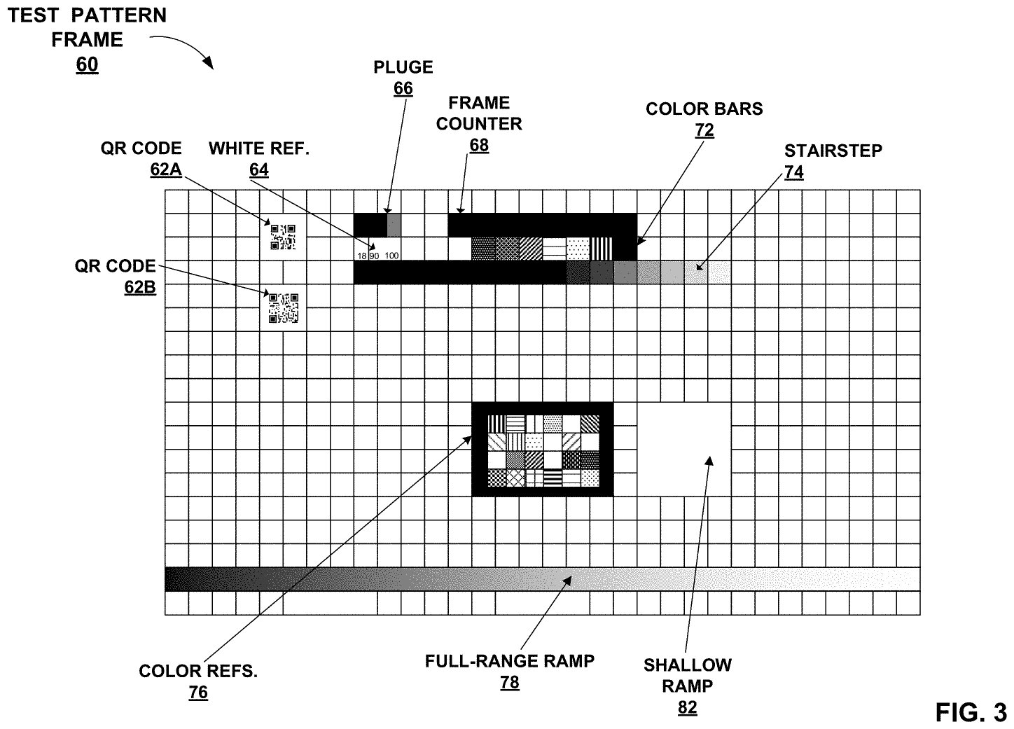

FIG. 3 is a conceptual diagram illustrating aspects of a frame of a predefined test pattern, in accordance with aspects of this disclosure. Test pattern frame 60 of FIG. 3 represents an example structure of a single image that content provider system 12 may include in a predefined test pattern of multimedia content 14. Content provider system 12 embeds two QR codes (namely, QR code 62A and QR code 62B, collectively, “QR codes 62”) in test pattern frame 60. Content provider system 12 generates QR code 62A to include information that identifies the type and version of the particular test pattern in which test pattern frame 60 is included. Content provider system 12 generates QR code 62B to include information about the original video parameters associated with multimedia content 14.

Content provider system 12 also includes one or more white reference tiles 64 in test pattern frame 60. White reference tile(s) 64 may be used by various devices analyzing test pattern frame 60 (e.g., quality assessment system 26) to set a baseline for what constitutes a white point or baseline in the context of the color space of multimedia content 14. Content provider system 12 also includes picture line-up generation equipment (or PLUGE) pattern 66 in test pattern frame 60. PLUGE pattern represents a pixel pattern used to calibrate the black level on a video monitor. “Black level” refers to the brightness of the darkest areas in the picture (e.g., very dark grays that often represent the darkest area of a picture).

Content provider system 12 also includes frame counter 68 in test pattern frame 60. Frame counter 68 represents a bit sequence that uniquely identifies test pattern frame 60 within multimedia content 14 by way of its luma distribution, as described above with respect to FIG. 2. Test pattern frame 60 includes color bars 72, in the example structure illustrated in FIG. 3. Color bars 72 include three YUV values for each of the eight color primaries, and are stored in an array of values, namely, ad->bars.yuv[3][8]. As described above with respect to FIG. 2, quality assessment system 26 may normalize color bars 72 during the quality assessment process. Because color bars 72 represent all of the YUV values for all of the color primaries, color bars 72 can also be referred to as “100% color bars” with respect to the test pattern of multimedia content 14 that includes test pattern frame 60.

Content provider system 12 generates test pattern frame 60 to also include stairstep 74. Stairstep 74 represents a series of Y (luma or luminance) chips that increase in increments of five, ten, or twenty units at each chip transition. Because chrominance signals are not always reproduced accurately, particularly at the low end and the high end of the luminance range, stairstep 74 provides a test signal to enable receiving devices, (e.g., quality assessment system 26) to determine the accuracy of reproduced chroma signals during changes in luminance. The signal of stairstep 74 displays a consistent chroma level through the changing luminance levels of the luminance chips that increment at each chip transition.

Content provider system 12 also embeds color references 76 in test pattern frame 60. By embedding color references 76 in test pattern frame 60, content provider system 12 enables quality assessment system 26 to determine baselines for the various chrominance values of test pattern frame 60, in the context of the color space in which test pattern frame 60 is expressed.

According to the example structure illustrated in FIG. 3, test pattern frame 60 also includes full-range ramp 78 and shallow ramp 82. Full-range ramp 78 represents a wide range luminance ramp that is a relatively continuous sequence of luminance values. Unlike the increment-based steps of stairstep 74, full-range ramp 78 represents a relatively gradual or “smooth” series of transitions across the full range of luminance values. Quality assessment system 26 may use the sequence of luminance values to develop an inverse LUT that quality assessment system 26 may in turn use instead of an inverse OETF.

Shallow ramp 82 contains a roughly even distribution of code values over a reduced or “shallow” range, as represented by the combination of the two LSBs of the overall ten-bit representation of the corresponding luminance values. Quality assessment system 26 may use shallow ramp 82 to perform bit-depth normalization of test pattern frame 60, and to compare RGB-domain bit depth information of test pattern frame 60 to one or more of reference samples 52 that are also expressed in RGB format.

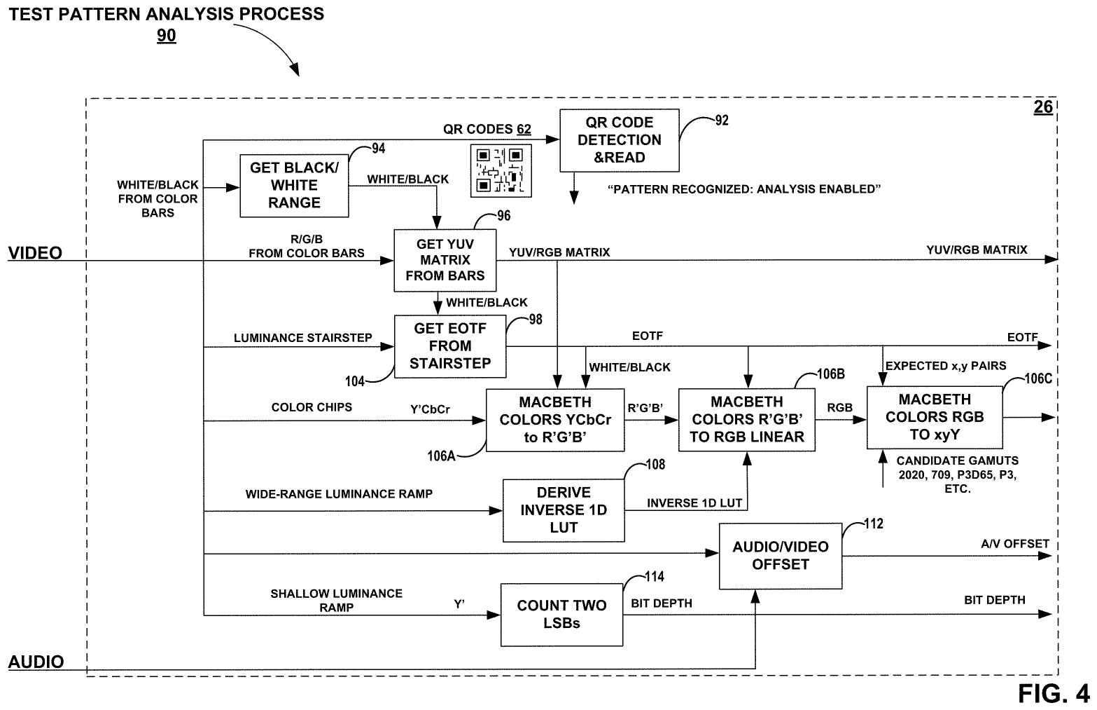

FIG. 4 is a data flow diagram (DFD) illustrating test pattern analysis process 90 that quality assessment system 26 may perform, in accordance with aspects of this disclosure. By analyzing video data of video test sample 24, quality assessment system 26 may obtain white and black reference information from color bars 72 (94), and may obtain the YUV matrix for RGB conversion from color bars 72 (96). Quality assessment system 26 may also detect and read QR codes 62 to determine that test pattern frame 60 is part of a predefined test pattern, and to determine the type and version of the test pattern. Based on these determinations from reading QR codes 62, quality assessment system 26 enables or initiates the analysis of test pattern frame 60 to determine the quality of multimedia content 14.

Quality assessment system 26 may obtain the EOTF for test pattern frame 60 using stairstep 74 (98) which, again, represents a series of step-based increments of luminance values. Using the various YUV values (namely, one Y value and two chrominance values U and V), quality assessment system 26 may apply a Macbeth color checking operation (106A) to obtain non-linear R′G′B′ values for test pattern frame 60. In turn, quality assessment system 26 may apply another Macbeth color checking operation (106B) to the non-linear R′G′B′ values to obtain linear RGB values for test pattern frame 60. The EOTF obtained at step 98 is the preferred input for step 106B, provided that step 98 yields an EOTF identification other than an “unknown” default value. If step 98 yielded an unknown EOTF, then quality assessment system 26 may resort to using an inverse one-dimensional lookup table, the derivation of which is described below.

Quality assessment system 26 may apply yet another Macbeth color checking operation (106C) to the linear RGB values to obtain linear CIE 1931 (or CIE xyY) color space data for test pattern frame 60. Various candidate color gamuts against which the linear RGB values may be evaluated are listed in FIG. 4 as example inputs to step 106C. Because errors in color information tend to be discrete, rather than widespread, quality assessment system 26 may match the expected (x, y) pairs to the candidate gamuts (each of which is a standard-defined gamut) on a trial-and-error basis, to determine the closest match.

Quality assessment system 26 may also use the wide-range luminance ramp (e.g., full-range ramp 78 of FIG. 3) to derive an inverse one-dimensional (1D) LUT (108). The 1D LUT derived at step 108 is used in step 106B to convert the non-linear R′G′B′ values to linear RGB values. Using an audio frame captured by mobile device 18 in conjunction with the image capture of test pattern frame 60, quality assessment system 26 may determine the audio/video (A/V) offset of multimedia content 14 as rendered at the playback location (112). Quality assessment system 26 may use the A/V offset in evaluating the quality of multimedia content 14 in terms of how well the video and audio components are aligned when delivered to the playback location over network 8.

Quality assessment system 26 may perform bit depth-based quality assessment techniques of this disclosure using a shallow luminance ramp, such as shallow ramp 82. Because bit-depth truncation often affects the lowest pair of bits, the values represented by the two LSBs for each respective code value (114) may be indicative of such a truncation. As discussed above, the combination of LSBs extracted in this manner from the code values yield one of four possible values, namely, a value selected from the set of {0, 1, 2, 3}. Statistical analysis of the frequency of occurrence of these four values will usually indicate whether the lowest two bits contain meaningful information.

Quality assessment system 26 may compare the resulting bit depth to the bit depth determined in this way for the corresponding reference content segment 52, to determine whether the quality of video test sample 24 indicates that multimedia content 14 was delivered to the destination (e.g., a playback location) with at least the previously agreed-upon quality level e.g. as may be set forth in a subscription agreement between the subscriber and the content provider. For example, quality assessment system 26 may automatically determine one or more characteristics of video test sample 24 to determine whether multimedia content 14, as delivered to the destination substantially match, exceed, or are below the levels of the agreed-upon quality level.

For instance, quality assessment system 26 may compare the determined characteristics of video test sample 24 to standard characteristics associated with the agreed-upon quality for multimedia content 14. Examples of standard characteristics include one or more of color space information, optical-to-electrical transfer function (OETF) information, gamma function information, frame rate information, bit depth information, color difference image subsampling information, resolution information, color volume information, sub-channel interleaving information, cropping information, Y′CbCr to R′G′B′ matrix information, /Y′UV to R′G′B′ matrix information, a black level value, a white level value, a diffuse white level, or audio-video offset information.

Example pseudocode for an operation set of this disclosure is listed below:

```
  getBitDepth( pic, ad );
  ConvertType( pic[0], pic[0], Float );
  ConvertType( pic[1], pic[1], Float );
  ConvertType( pic[2], pic[2], Float );
  getInputParams( pic, ad );
    getAliasing1920To1280( pic, ad );
    getAliasing2to1( pic, ad );
    getAliasingChroma420( pic, ad );
  // analysis steps. The order matters!
    getColorbarValues( pic, ad );
    getDimColorbarValues( pic, ad );
    getFrameNum( pic, ad );
  getMatrixFromBarsValues( ad )  ;
    getTransferFunction( pic, ad );
    getLUT_1D_v2( pic, ad ); // from the linear light Ramp
    // getMaxBrightness( pic, ad ); // must know EOTF, 1D LUT not good enough
  getDiffuseWhite( pic, ad );
    getPLUGE( pic, ad );
  getWhitePLUGE( pic, ad );
    getContainerGamut( pic, ad );
getSdi2SI( pic, ad );
```

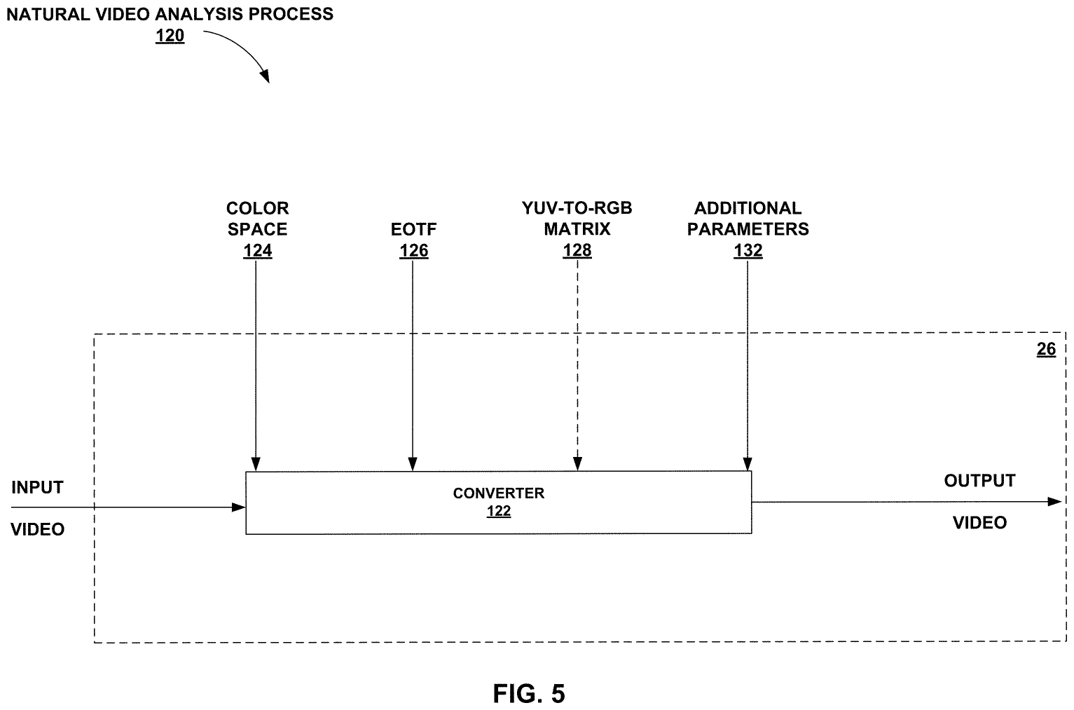

FIG. 5 is a data flow diagram (DFD) illustrating natural video analysis process 120 that quality assessment system 26 may perform, in accordance with aspects of this disclosure. To analyze natural video (or ad hoc video) data included in video test sample 24, quality assessment system 26 leverages labeled datasets of training data 54, with independently controlled video parameters from known, labeled source video information. Again, quality assessment system 26 may use source video originating in various color spaces, with various parameters. The example discussed with reference to FIG. 5 pertains to source video originating in the 709 color space, with a 1886 gamma, with a 709 YUV-to-RGB color conversion matrix.

Quality assessment system 26 may convert the source video material (in the format and with the parameters described above) to a labeled video segment, with each parameter under independent control. With respect to the color space information and the RGB container gamut of the source video, quality assessment system may produce converted content in the P3 color space, the CIE 2020 color space, or in various other color spaces, other than the 709 color space source video content, discussed below. With respect to the EOTF, quality assessment system 26 may produce source video content in PQ, HLG, S-Log3, or other EOTFs, other than the 1886 gamma discussed below. With respect to the YUV-to-RGB color conversion matrix, quality assessment system 26 may produce source video content using 601 and 2020 matrices, other than the 709 matrix discussed below.

Converter 122 of FIG. 5 may include, be, or be part of various components of quality assessment system 26 shown in FIG. 2, such as natural video analysis circuitry 42 and/or training data 54 stored to storage device(s) 48. Natural video analysis process 120 of FIG. 5 represents the conversion portions of the natural video quality assessment techniques of this disclosure. Conversion module receives input video data (e.g., in the form of source video to be used to form training data 54), and converts the input video data according to the techniques of this disclosure described below. Converter 122 receives additional inputs in the form of color space 124, EOTF 126, YUV-to-RGB matrix 128, and additional parameters 132, and uses these additional inputs as operands in converting the input video data to output video data that can be used in the comparison process against training data 54.

Based on different independent permutations of the data received for color space 124, EOTF 126, YUV-to-RGB matrix 128 (if applicable), and additional parameters 132, converter 122 may form output video data that expresses the input video data in a quality-assessable form. The input of YUV-to-RGB matrix 128 is shown using a dashed line to illustrate that the matrix is an optional input, because YUV-to-RGB matrix 128 is not required in instances in which the input video data is already in RGB format. For each input permutation, converter 122 produces a different output video, and adds a unique label to each such output.

Table 1 below illustrates various options for color space 124, EOTF 126, YUV-to-RGB matrix 128, and additional parameters 132:

TABLE 1

| Container Gamut | 709, P3, 2020 |
|---|---|
| EOTF/Gamma | 1886, PQ, HLG |
| YUV-to-RGB Matrix | 709, 2020 |

In this example, if the input video is supplied in 709 color space, with a 1886 gamma, and uses the 709 YUV-to-RGB conversion matrix, converter 122 may produce the output video data in the formats shown below in Table 2:

TABLE 2

| | Color | | YUV-to-RGB |
|---|---|---|---|
| | Space | EOTF/Gamma | Matrix |
| Output Video 1 | 709 | 1886 | 2020 |
| Output Video 2 | 709 | P1 | 709 |
| Output Video 3 | 709 | HLG | 709 |
| Output Video 4 | 709 | PQ | 2020 |
| Output Video 5 | 709 | HLG | 2020 |
| Output Video 6 | P3 | 1886 | 709 |
| Output Video 7 | P3 | 1886 | 2020 |
| Output Video 8 | P3 | PQ | 709 |
| Output Video 9 | P3 | PQ | 2020 |
| Output Video 10 | P3 | HLG | 709 |
| Output Video 11 | P3 | HLG | 2020 |
| Output Video 12 | 2020 | 1886 | 2020 |
| Output Video 13 | 2020 | 1886 | 2020 |
| Output Video 14 | 2020 | PQ | 709 |
| Output Video 15 | 2020 | PQ | 2020 |
| Output Video 16 | 2020 | HLG | 709 |
| Output Video 17 | 2020 | HLG | 2020 |

Upon populating training data 54 with a dataset of at least a threshold size, natural video analysis circuitry 42 may perform supervised learning to create ML/AI algorithms to classify color space, EOTF/gamma, and YUV-to-RGB matrix from natural video (or ad hoc video) included in video test sample 24. Natural video analysis circuitry 42 may employ these ML/AI algorithms (trained using the dataset(s) of training data 54) in instances in which test pattern analysis circuitry 36 does not detect a predefined test pattern associated with an image received via communication circuitry 32.

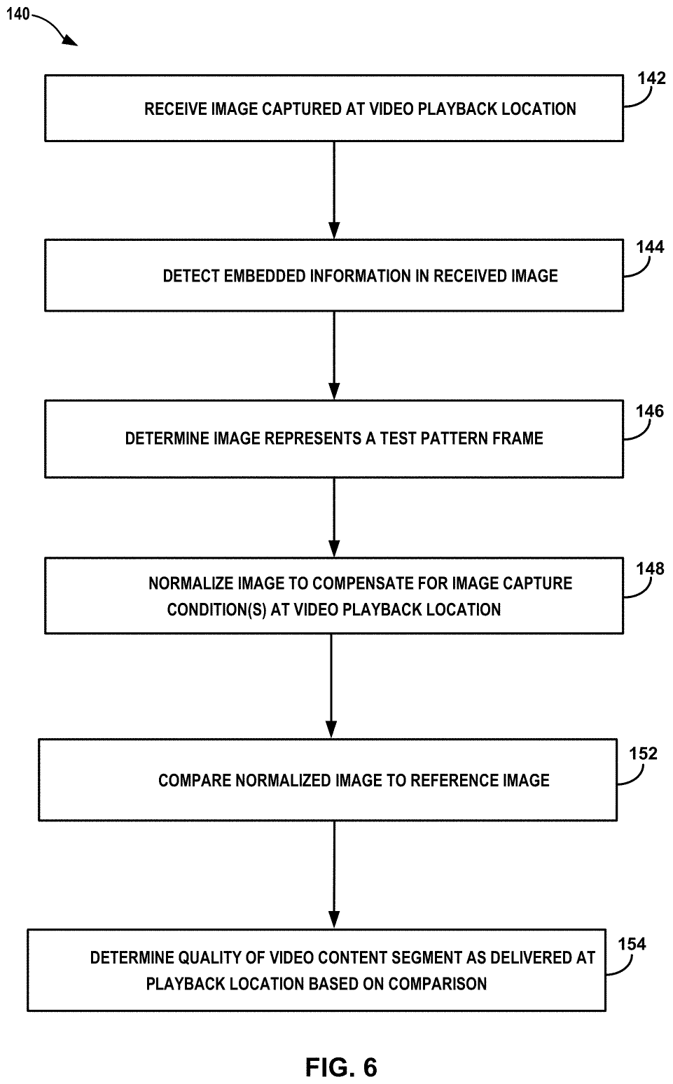

FIG. 6 is a flowchart illustrating process 140, which quality assessment system 26 may perform in accordance with aspects of this disclosure. Process 140 may begin when communication circuitry 32 receives an image captured at the playback location (142) at which subscriber device 16 and mobile device 18 are deployed. Test pattern analysis circuitry 36 may detect embedded information in the image received via communication circuitry 32 (144). For instance, test pattern analysis circuitry 36 may detect one or both of QR codes 62 described above with respect to FIGS. 3 and 4. In turn, test pattern analysis circuitry 32 may determine that the image received via communication circuitry 32 is a frame of a predefined test pattern of multimedia content 14 (146). For instance, in response to detecting one or both of QR codes 62 in the received image, test pattern analysis circuitry 36 may identify the received image as test pattern frame 60 of FIG. 3.

Normalization engine 38 may normalize test pattern frame 60 to compensate for one or more image capture conditions at the playback location (the destination) at which video output 6 is rendered for display (148). Various normalization operations that normalization engine 38 may apply in accordance with this disclosure are described above with respect to FIGS. 1-4. In this way, normalization engine 38 enables video quality assessment via cell phone camera capture or other types of informal camera capture at the playback location (the destination of video output 6), by compensating for one or more image capture conditions that may distort video test sample 24 in comparison to the actual playback quality of video output 6. Examples of image capture-based quality distortions for which normalization engine 38 may compensate jitter (e.g., via stabilization), parallax (e.g., via rotation), lighting issues (e.g., via filtering), etc.

Content quality analysis circuitry 46 may compare the normalized version of test pattern frame 60 (i.e., a normalized image) to one or more reference images of reference content segments 52 (152). Based on the comparison, content quality analysis circuitry 46 may determine the quality of test segment 22 (and thereby, multimedia content 14 as a whole) as delivered at the playback location at which subscriber device 16 and mobile device 18 are deployed (154).

In one or more examples, the functions described above may be implemented in hardware, software, firmware, or any combination thereof. For example, various devices and/or components of the above-described drawings may be implemented in hardware, software, firmware, or any combination thereof. If implemented in software, the functions may be stored on or transmitted over, as one or more instructions or code, a computer-readable medium and executed by a hardware-based processing unit, i.e. processing circuitry. Computer-readable media may include computer-readable storage media, which corresponds to a tangible medium such as data storage media, or communication media including any medium that facilitates transfer of a computer program or data from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product such as an application may also include a computer-readable medium as well as sent through network 330, stored in memory 316 and executed by processing circuitry 302.

By way of example, and not limitation, such computer-readable storage media, may include memory 316. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system configured to assess video content, the computing system comprising:
an interface configured to receive an image captured at a destination of the video content;
a memory in communication with the interface, the memory being configured to store the received image and at least a portion of a reference image associated with the video content; and
processing circuitry in communication with the memory, the processing circuitry being configured to:
detect embedded information in the image, the embedded information indicating that the image represents a frame of a test pattern of the video content;
utilize an implicit knowledge of the test pattern to compare at least a portion of the image to the portion of the reference image stored to the memory; and
automatically determine, based on the comparison, one or more characteristics of the video content segment as delivered at the destination.

2. The computing system of claim 1, wherein the processing circuitry is further configured to:
determine that the one or more characteristics of the video content are different from one or more standard characteristics of a source associated with the video content; and
signal, via the interface, a communication to a third-party system indicating that the one or more characteristics of the video content are different from the one or more standard characteristics of the source associated with the video content.

3. The computing system of claim 2, wherein the one or more standard characteristics include one or more of color space information, optical-to-electrical transfer function (OETF) information, gamma function information, frame rate information, bit depth information, color difference image subsampling information, resolution information, color volume information, sub-channel interleaving information, cropping information, Y′CbCr to R′G′B′ matrix information, Y′UV to R′G′B′ matrix information, a black level value, a white level value, a diffuse white level, or audio-video offset information.

4. The computing system of claim 1, wherein the image is represented in a first color representation, and wherein to normalize the image, the processing circuitry is configured to: sample one or more pixels of the image; and
convert the sampled one or more pixels to converted pixels represented in a second color representation.

5. The computing system of claim 1, wherein the processing circuitry is further configured to:
determine a frequency of occurrence of values associated with one or more least significant bits (LSBs) associated with the portion of the image; and
determine, based on the determined frequency of occurrence of the values associated with the pair of LSBs, whether the portion of the image has undergone bit-depth truncation associated with the one or more LSBs,
wherein to the one or more characteristics of the video content segment as delivered at the destination, the processing circuitry is configured to the one or more characteristics of the video content segment as delivered at the destination based on the determination whether the portion of the image has undergone the bit-depth truncation.

6. The computing system of claim 1,
wherein the interface is further configured to receive an audio frame captured at the destination of the video content, the audio frame corresponding to the received image,
wherein the memory is further configured to store the received audio frame, and
wherein to determine the quality of the video content segment as delivered at the destination, the processing circuitry is further configured to:
determine a time offset between the received audio frame and the received image; and
determine an audio-video offset of the video content segment based on the time offset determined between the received audio frame and the received image.

7. A computing system configured to assess video content, the computing system comprising:
an interface configured to receive an image captured at a destination of the video content;
a memory in communication with the interface, the memory being configured to store the received image, a first training data set with a first set of known video characteristics, and one or more additional training data sets synthesized from the first training data set with respective sets of known video characteristics that are variations of the first set of known video characteristics; and
processing circuitry in communication with the memory, the processing circuitry being configured to apply a machine learning system trained with the first training data set and the one or more additional training data sets synthesized from the first training data set to classify one or more characteristics of the received image to form a measured classification.

8. The computing system of claim 7, wherein the processing circuitry is further configured to:
compare the measured classification to one or more user-provided specifications; and
signal, via the interface, to a user device, any differences detected between the one or more user-provided specifications based on the comparison.

9. The computing system of claim 7, wherein the processing circuitry is further configured to modify one of metadata or pixels associated with the video content based on the measured classification to modify a visual rendering of the video content at the destination.

10. A method of assessing video content, the method comprising:
receiving, by a computing device, an image captured at a destination of the video content;
storing, to a memory of the computing device, the received image and at least portion of a reference image associated with the video content;
detecting, by the computing device, embedded information in the image, the embedded information indicating that the image represents a frame of a test pattern of the video content;
utilizing, by the computing device, an implicit knowledge of the test pattern to compare at least a portion of the image to the stored portion of the reference image; and
automatically determining, by the computing device, based on the comparison, one or more characteristics of the video content segment as delivered at the destination.

11. The method of claim 10, further comprising:
determining, by the computing device, that the one or more characteristics of the video content are different from one or more standard characteristics of a source associated with the video content; and
signaling, by the computing device, a communication to a third-party system indicating that the one or more characteristics of the video content are different from the one or more standard characteristics of the source associated with the video content.

12. The method of claim 11, wherein the one or more standard characteristics include one or more of color space information, optical-to-electrical transfer function (OETF) information, gamma function information, frame rate information, bit depth information, pixel metadata, color difference image subsampling information, resolution information, color volume information, sub-channel interleaving information, cropping information, Y′CbCr to R′G′B′ matrix information, Y′UV to R′G′B′ matrix information, a black level value, a white level value, a diffuse white level, or audio-video offset information.

13. The method of claim 10, wherein the image is represented in a first color representation, the method further comprising:
sampling, by the computing device, one or more pixels of the image; and
converting, by the computing device, the sampled one or more pixels to converted pixels represented in a second color representation.

14. The method of claim 10, further comprising:
determining a frequency of occurrence of values associated with one or more least significant bits (LSBs) associated with the portion of the image; and
determining, based on the determined frequency of occurrence of the values associated with the pair of LSBs, whether the portion of the image has undergone bit-depth truncation associated with the one or more least significant bits (LSBs),
wherein the one or more characteristics of the video content segment as delivered at the destination comprise the one or more characteristics of the video content segment as delivered at the destination based on the determination whether the portion of the image has undergone the bit-depth truncation.

15. The method of claim 10, further comprising:
receiving an audio frame captured at the destination of the video content, the audio frame corresponding to the received image,
determine a time offset between the received audio frame and the received image; and
determine an audio-video offset of the video content segment based on the time offset determined between the received audio frame and the received image.

16. The method of claim 10, further comprising modifying one of metadata or pixels associated with the multimedia content based on the determined characteristics of the video content to modify a visual rendering of the multimedia content at the destination.

17. A non-transitory computer-readable storage medium encoded with instructions that, when executed, cause processing circuitry of a computing device to:
receive an image captured at a destination of the video content;
store, to the non-transitory computer-readable storage medium, the received image and at least a portion of a reference image associated with the video content;
detect embedded information in the image, the embedded information indicating that the image represents a frame of a test pattern of the video content;
utilize an implicit knowledge of the test pattern to compare at least a portion of the image to the stored portion of the reference image; and
automatically determine, based on the comparison, one or more characteristics of the video content segment as delivered at the destination.

18. The non-transitory computer-readable storage medium of claim 17, further encoded with instructions that, when executed, cause the processing circuitry of the computing device to:
modify one of metadata or pixels associated with the multimedia content based on the determined characteristics of the video content to modify a visual rendering of the multimedia content at the destination.

19. A method for synthesizing one or more additional training data sets with respective sets of known video characteristics, the method comprising:
obtaining, by a computing system, a first training data set with a first set of known video characteristics; and
modifying the first training data set to synthesize each of the one or more additional training data sets as a respective variation of the first training data set, wherein each respective set of known video characteristics associated with the one or more additional data sets represents a respective variation of the first set of known video characteristics associated with the first training data set.

20. The method of claim 19, further comprising training, by the computing system, a classifier of a machine learning system to assess one or more characteristics of video content, wherein training the classifier comprises using the first training data set and each of the one or more additional training data sets synthesized using the first training data set.
